(19) United States
(12) Patent Application Publication
(10) Pub. No.: US 2019/0207864 A1
(43) Pub. Date: Jul. 4, 2019

(54) COMMUNICATION APPARATUS AND BANDWIDTH CONTROL METHOD

(71) Applicant: Mitsubishi Electric Corporation, Tokyo (JP)

(72) Inventors: Sachiko TANIGUCHI, Tokyo (JP); Yuji GOTO, Tokyo (JP)

(73) Assignee: Mitsubishi Electric Corporation, Tokyo (JP)

(21) Appl. No.: 16/311,641

(22) PCT Filed: Aug. 22, 2016
(86) PCT No.: PCT/JP2016/074370

§ 371 Date: Dec. 19, 2018

(51) Int. Cl. H04L 12/823; H04W 24/08

(52) U.S. Cl. CPC H04L 47/32; H04W 24/08

(57) ABSTRACT

A communication apparatus according to the present invention includes a policer unit that, when notified of start of reception of a first frame, determines whether to discard or transfer the first frame on a basis of rate information indicating an amount of data per unit time calculated on a basis of a frame length and reception timing of a second frame received before the first frame; and a transfer processing unit that transfers the first frame in a cut-through mode, the first frame being determined by the policer unit to be transferred.

### FIELD

The present invention relates to a communication apparatus and a bandwidth control method for controlling a bandwidth of a frame to be transferred.

### BACKGROUND

In general, control frames having stored therein control information on devices, and other frames having information other than the control information such as video information are transmitted and received in industrially used networks including networks in factories, industrial plants, trains, and automobiles. In many cases, the transmission and reception of the control frame occurs periodically. The industrially used networks are often required to provide high-precision synchronous control between devices or control that emphasizes on real-time property. For this reason, in the industrially used networks, it is required to transfer the control frame in a manner accommodating a strict latency-related request, that is, to transfer the control frame with low-latency.

The industrially used networks are now shifting to networks compatible with Ethernet (registered trademark) standards. A store-and-forward mode is known as a transfer mode employed by a relay apparatus for relaying an Ethernet frame that is a frame compatible with the Ethernet standards. The store-and-forward mode involves temporarily storing all frames in a buffer before transferring the frames. For this reason, processing latency occurs in the relay apparatus using the store-and-forward mode, but it is possible to detect a frame abnormality such as an abnormality in the length of a frame and an abnormality in frame data, and then discard the frame having such an abnormality detected.

Besides the store-and-forward mode, there is a cut-through mode as a transfer mode employed by a relay apparatus for relaying an Ethernet frame. The cut-through mode is used in transferring a frame in real time. The cut-through mode, which is a mode of transferring a frame on the basis of information of a header part of the frame, enables transfer of a frame to a subsequent apparatus without storing entire data equivalent to one frame in a buffer. The cut-through mode has advantages: no occurrence of transfer latency fluctuation depending on a frame length; and transfer of frames with low latency. However, when a frame that can be determined as abnormal only at the end of the frame is transferred in the cut-through mode, there is a possibility that the relay apparatus does not discard but transfer an abnormal frame, which should be discarded under ordinary circumstances. Failure to discard frames that should be otherwise discarded under ordinary circumstances puts a squeeze on a bandwidth of the network.

On the other hand, a relay apparatus may employ a method for restricting a bandwidth as a method for securing communication between normal devices by suppressing excessive traffic of the network when a device that transmits a large number of frames due to misconfiguration, erroneous connection, malfunction or failure of the device exists in the network. Such a bandwidth limitation method is generally called “policing”. The relay apparatus that performs policing monitors a bandwidth of traffic subject to the bandwidth limitation and discards a frame of the traffic subject to the bandwidth limitation when the bandwidth of the traffic subject to the bandwidth limitation exceeds a preset bandwidth.

The conventional bandwidth limitation method is based on the store-and-forward transfer mode. For example, Patent Literature 1 discloses a frame control apparatus that stores received frames temporarily in a buffer, reads the frames after a lapse of a fixed time and discards a frame including an error, such that the frame control apparatus performs bandwidth limitation by using a frame length of a normal frame.

### CITATION LIST

### Patent Literature

Patent Literature 1: Japanese Patent No. 5750387

### SUMMARY

### Technical Problem

According to the technique described in Patent Literature 1, the frame control apparatus, i.e., a relay apparatus transfers the frames in the store-and-forward mode. For this reason, unfortunately, the processing latency is large as compared with the transfer in the cut-through mode. Thus, the technique described in Patent Literature 1 is not suitable for transfer of a frame requiring transferring with low latency, such as a control frame in the industrially used networks.

In the technique described in Patent Literature 1, the bandwidth limitation process uses a frame length of a frame subject to determination of whether the frame should be discarded due to the bandwidth limitation. For a relay apparatus that performs the transfer in the cut-through mode, the frame length of the frame subject to determination of whether the frame should be discarded due the bandwidth limitation can fail to be acquired because the relay apparatus may start the transfer before finishing receiving a frame. Thus, the bandwidth limitation method described in Patent Literature 1 cannot be directly applied to the relay apparatus that performs transfer in the cut-through mode.

The present invention has been made in view of the above, and an object thereof is to obtain a communication apparatus capable of achieving transfer in the cut-through mode and performing bandwidth limitation as well.

### Solution to Problem

To solve the above problem and achieve the object, a communication apparatus according to the present invention comprises a bandwidth limitation unit to, when bandwidth limitation unit is notified of start of reception of a first frame, determine whether to discard or transfer the first frame on a basis of rate information indicating an amount of data per unit time calculated on a basis of a frame length and reception timing of a second frame received before the first frame. The communication apparatus further comprises a transfer processing unit to transfer the first frame in a cut-through mode, the first frame being determined by the bandwidth limitation unit to be transferred.

### Advantageous Effects of Invention

The communication apparatus according to the present invention has an effect of achieving transfer in the cut-through mode and performing bandwidth limitation as well.

### BRIEF DESCRIPTION OF DRAWINGS

FIG. 1 is a diagram illustrating an example configuration of a communication apparatus according to a first embodiment.

FIG. 2 is a diagram illustrating an example configuration of a policer unit of the first embodiment.

FIG. 3 is a flowchart illustrating an example of an overall operation performed by the communication apparatus of the first embodiment.

FIG. 4 is a flowchart illustrating an example of a processing procedure of transfer determination in Step S6 of FIG. 3.

FIG. 5 is a diagram illustrating an example configuration of a transfer processing unit of the first embodiment.

FIG. 6 is a diagram illustrating an example configuration of the transfer processing unit of the first embodiment.

FIG. 7 is a diagram illustrating a processing circuit of the first embodiment

FIG. 8 is a diagram illustrating an example configuration of a control circuit of the first embodiment.

FIG. 9 is a diagram illustrating an example configuration of a communication apparatus according to a second embodiment.

FIG. 10 is a diagram illustrating an example configuration of an error-state monitoring unit of the second embodiment.

FIG. 11 is a diagram illustrating an example configuration of a policer unit of the second embodiment.

FIG. 12 is a flowchart illustrating an example of a processing procedure performed by the error-state monitoring unit of the second embodiment.

FIG. 13 is a flowchart illustrating an example of an overall operation performed by the communication apparatus of the second embodiment.

FIG. 14 is a flowchart illustrating an example of a processing procedure of transfer determination in Step S6a of FIG. 13.

FIG. 15 is a diagram illustrating an example configuration of a communication apparatus of the second embodiment in a case where discard of a frame is performed by a component other than the policer unit.

FIG. 16 is a diagram illustrating an example configuration of a communication apparatus according to a third embodiment.

FIG. 17 is a diagram illustrating an example configuration of a policer unit of the third embodiment.

FIG. 18 is a diagram illustrating an example configuration of a communication apparatus according to a fourth embodiment.

FIG. 19 is a diagram illustrating another example configuration of a policer unit of the fourth embodiment.

### DESCRIPTION OF EMBODIMENTS

Hereinafter, a communication apparatus and a bandwidth control method according to each embodiment of the present invention will be described in detail with reference to the drawings. The invention is not limited to the embodiments.

### First Embodiment

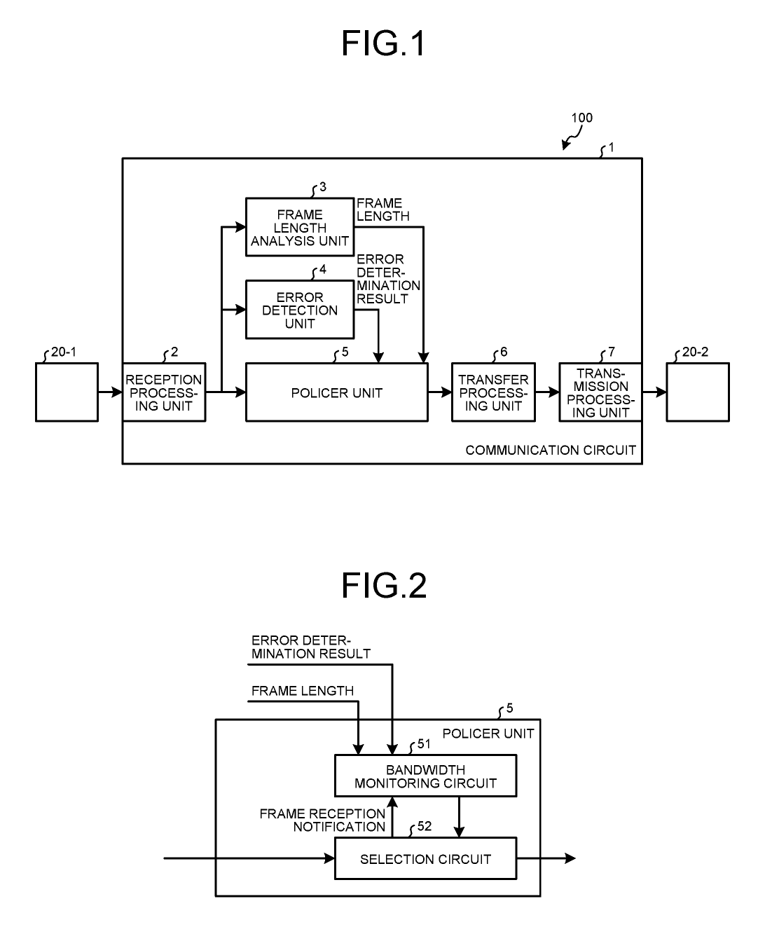

FIG. 1 is a diagram illustrating an example configuration of a communication apparatus according to a first embodiment of the present invention. As illustrated in FIG. 1, the communication apparatus 100 of the first embodiment includes a communication circuit 1 and ports 20-1 and 20-2 that are communication ports. The communication circuit 1 includes a reception processing unit 2, a frame length analysis unit 3, an error detection unit 4, a policer unit 5, a transfer processing unit 6, and a transmission processing unit 7.

In FIG. 1, one port on a reception side and one port on a transmission side are illustrated, but the number of ports of the communication apparatus 100 is not limited to this example. Generally, the transmission side and the reception side each include a plurality of ports. When there is a plurality of ports on the reception side, the reception processing unit 2, the frame length analysis unit 3, the error detection unit 4, and the policer unit 5 are provided for each port on the reception side. The transmission processing unit 7 is provided for each port on the transmission side.

The communication apparatus 100 transfers a frame that is required to be transferred in real-time or transferred with low-latency, such as a control frame in industrially used networks. The frame transferred by the communication apparatus 100 is, for example, an Ethernet (registered trademark) frame. The communication apparatus 100 includes at least two ports, and transfers a frame, which has been received at one port, to another port in a cut-through mode. The transfer in the cut-through mode is hereinafter referred to as cut-through transfer where appropriate, and transfer in a store-and-forward mode is hereinafter referred to as store-and-forward transfer where appropriate. Although the example illustrated in FIG. 1 employs a configuration in which the cut-through transfer is performed, a configuration in which both cut-through transfer and store-and-forward transfer are performed may be employed as will be described later.

The reception processing unit 2 performs a reception process such as a process on a physical layer of a frame received by the port 20-1, and outputs the frame having been subjected to the reception process, to the frame length analysis unit 3, the error detection unit 4, and the policer unit 5.

The frame length analysis unit 3 is a measurement unit that measures a frame length of the received frame. Specifically, the frame length analysis unit 3 measures a bit length from a beginning portion of the input frame by using a counter or the like, and, when the frame length analysis unit 3 receives the end of the frame, outputs the measured bit length as a frame length.

The error detection unit 4 performs an error detection process on the input frame to thereby determine whether an error is present. That is, the error detection unit 4 determines whether there is an error in the frame. The frame, which has been determined as including an error by the error detection process performed by the error detection unit 4, is discarded in a process in a subsequent stage. In other words, the error detection process performed by the error detection unit 4 is an error detection process used for determination of whether to discard a frame. The error detection process is at least one of: an error detection process using redundant information stored in a frame check sequence (FCS) field added to an Ethernet frame; and a process of detecting an error such as a transmission path reception error and a length error when generally receiving a frame. The transmission path reception error is an error detected by using error detection information added by, for example, a 4B/5B code or 8B/10B code of the Ethernet. The length error means that a length of a frame stored in a length field of the header of the frame is different from a length of the frame actually measured. The error detection process performed by the error detection unit 4 is not limited to the above examples. In the Ethernet frame, redundant information for cyclic redundancy check (CRC) is stored in the FCS field. The error detection process may be one kind of process or a combination of multiple processes. In a case where the error detection process is a combination of multiple processes, the error detection unit 4 may determine that there is an error in the frame when the error is detected in any one of the processes. Alternatively, the error detection unit 4 may determine that there is an error in the frame when the error is detected in all of the processes.

FIG. 2 is a diagram illustrating an example configuration of the policer unit 5 of the first embodiment. As illustrated in FIG. 2, the policer unit 5 includes a bandwidth monitoring circuit 51 and a selection circuit 52.

On the basis of a frame length input from the frame length analysis unit 3 and an error detection result input from the error detection unit 4, the bandwidth monitoring circuit 51 obtains rate information that is a bandwidth of a frame output from the policer unit 5. The rate information is information indicating the amount of data per unit time of a frame output from the policer unit 5. The bandwidth monitoring circuit 51 determines whether the rate information is equal to or greater than a predetermined threshold, and determines whether to discard or transfer the frame depending on a result of the determination. Although an example in which the bandwidth monitoring circuit 51 determines whether the rate information is equal to or greater than the threshold will be described below, the bandwidth monitoring circuit 51 may determine whether the rate information exceeds the threshold instead of determining whether the rate information is equal to or greater than the threshold.

The processes performed by the bandwidth monitoring circuit 51, i.e., the process of obtaining the rate information and the process of determining whether the rate information is equal to or greater than the predetermined threshold to thereby determine whether to discard the frame are called policing. The policing process performed by the bandwidth monitoring circuit 51 can employ a commonly used scheme such as a token bucket scheme or a jumping window scheme. The token bucket scheme, which is described also in Patent Literature 1, uses a counter value corresponding to a frame length, which is called a token. The jumping window scheme clears a counter value corresponding to a frame length at regular time intervals. The policing method is not limited to these, and any method may be used. In either method, the bandwidth of a frame to be sent is kept below the threshold or equal to or greater the threshold. To this end, it is necessary to monitor the amount of data per unit time of the frame to be sent, in this case, the frame to be output from the policer unit 5.

Policing performed by the bandwidth monitoring circuit 51 will be described with reference to, by way of example, the token bucket scheme. The token bucket scheme uses a counter value corresponding to a frame length, which is called a token, and uses a bucket for storing the token. The token is added to the bucket at a rate corresponding to a preset bandwidth threshold. Upon receiving a frame, the bandwidth monitoring circuit 51 determines to send, i.e., transfer the frame when tokens in the bucket are enough to send the frame, such that the tokens corresponding to a frame length of the frame are subtracted from the bucket. On the other hand, when tokens in the bucket are not enough to send the frame, the bandwidth monitoring circuit 51 determines to discard the frame; thus, no token is subtracted from the bucket. Through the above process, the bandwidth monitoring circuit 51 can enables the amount of data of the frame output from the policer unit 5 per unit time to be less than the threshold. Whether the amount of data of the frame output from the policer unit 5 per unit time is kept less than the threshold, or equal to or less than the threshold depends on setting for determining to transfer the frame or setting for determining to discard the frame, when the bucket becomes empty in determination whether there are enough tokens in the bucket to send the frame. In order to determine to discard the frame when the amount of data of the frame output from the policer unit 5 is equal to or greater than the threshold, it is required to determine to discard the frame when the bucket becomes empty.

Specifically, upon receiving, from the selection circuit 52, a frame reception notification indicating that the reception of the frame has been started, the bandwidth monitoring circuit 51 determines whether the rate information is equal to or greater than the threshold, and determines whether to discard or transfer the frame depending on a result of the determination. This determination is often called “transfer determination by policing”. In the present embodiment, threshold determination by policing is made before measurement of a frame length of the frame currently input to the policer unit 5 is finished. For this reason, the rate information used for the threshold determination when the frame reception notification is input is a value based on a frame length of at least one previously input frame including a frame input immediately before the currently input frame. Therefore, the amount of data actually output per unit time may exceed the threshold by one frame. However, an excess of one frame, which occurs due to the threshold being sufficiently larger than the frame length, does not pose a problem. A value smaller by one frame, for example, a value smaller by a possible maximum frame length, than an upper limit value of the bandwidth output from the policer unit 5 may be set as the threshold. The threshold setting method is not limited to this example.

After the result of the transfer determination is retained and an error detection result is input, the bandwidth monitoring circuit 51 determines whether to discard the frame depending on the result of the transfer determination by policing and the error detection result, and notifies the selection circuit 52 of a result of the determination. After the frame length and an error determination result are input from the frame length analysis unit 3, the bandwidth monitoring circuit 51 determines whether to add the frame length to the rate information, depending on the determination result as to whether to discard the frame. Whether to add the frame length to the rate information is whether a token is subtracted from the bucket in a case where the token bucket method is used. The rate information is reset, that is, set to 0, per unit time. This is equivalent to adding to the bucket a token corresponding to the threshold in the token bucket mode.

Specifically, when it is determined to discard the frame by the above-mentioned policing, i.e., the transfer determination, the bandwidth monitoring circuit 51 determines to discard the frame regardless of the presence or absence of an error. When it is determined to transfer the frame by the policing but there is an error in the frame, the bandwidth monitoring circuit 51 determines to discard the frame. That is, the bandwidth monitoring circuit 51 determines to discard a first frame determined by the error detection unit 4 as including an error. Thus, in a case where the frame is determined to include no error and is determined by the policing to be transferred, when it is determined to discard the frame, the bandwidth monitoring circuit 51 outputs a frame discard instruction to the selection circuit 52. When the bandwidth monitoring circuit 51 determines not to discard the frame, the bandwidth monitoring circuit 51 outputs a frame transfer instruction to the selection circuit 52. Alternatively, the bandwidth monitoring circuit 51 needs not determine to discard the frame in accordance with the error detection result. For some type of an error detection process, for example, the bandwidth monitoring circuit 51 cannot determine whether an error is present until the last part of the frame is received. In such a case, the delay in transferring the frame may occur because the transfer should be held on standby until an error detection result is obtained. In view of such an issue, therefore, it is not necessary for the bandwidth monitoring circuit 51 to determine to discard the frame in accordance with the error detection result. On the other hand, the delay in transferring the frame is short even when the bandwidth monitoring circuit 51 determines to discard the frame in accordance with the error detection result, provided that the determination of whether an error is present can be made upon receipt of the vicinity of the beginning of a frame such as a frame header, or a portion of the frame closer to the beginning than to a front half of the frame. As described above, it is possible to set, depending on allowable delay and the type of error detection, whether to perform determination to discard the frame in accordance with the error detection result.

As described above, the bandwidth monitoring circuit 51 is a bandwidth limitation unit. When notified of the start of the reception of the first frame that is the received frame, the bandwidth limitation unit determines whether to discard or transfer the first frame on the basis of the rate information. The rate information indicates the amount of data per unit time calculated on the basis of a frame length and reception timing (time) of a second frame that is a frame received before the first frame. The first frame, which is received by the communication apparatus 100, is a frame being input to the policer unit 5. The second frame is at least one frame input before the frame being input to the policer unit 5. That is, the second frame is at least one frame received by the communication apparatus 100 in the past.

Upon detecting the start of input of the frame from the reception processing unit 2, the selection circuit 52 outputs a frame reception notification to the bandwidth monitoring circuit 51. The selection circuit 52 retains the beginning to middle of the frame from the time of start of input of the frame until the selection circuit 52 receives from the bandwidth monitoring circuit 51 an instruction, i.e., a frame discard instruction or a frame transfer instruction. On the basis of the instruction from the bandwidth monitoring circuit 51, then, the selection circuit 52 discards or transfers the frame input from the reception processing unit 2. Specifically, the selection circuit 52 outputs the frame to the transfer processing unit 6 when transferring the frame.

The transfer processing unit 6 outputs the frame input from the policer unit 5, to the transmission processing unit 7 by the cut-through transfer. That is, the transfer processing unit 6 performs the cut-through transfer of the first frame which the bandwidth monitoring circuit 51 of the policer unit 5 determines to transfer. The cut-through transfer also includes a transfer method called interspersing express traffic (IET) of which standardization has been advanced by Institute of Electrical and Electronics Engineers (IEEE) 802.3br in recent years. When there exists a plurality of ports on the transmission side, the transfer processing unit 6 retains a table that stores information indicating correspondence between a destination address stored in a header of a frame and an output port to output such a frame. The transfer processing unit 6 consults the table to identify the port corresponding to the destination address, and outputs the frame to the transmission processing unit 7 corresponding to the port. As will be described later, the transfer processing unit 6 may have a function of performing the store-and-forward transfer as well as the cut-through transfer. In that case, on the basis of the information stored in the header of the received frame, the transfer processing unit 6 determines whether to perform the cut-through transfer or the store-and-forward transfer, such that the transfer processing unit 6 selects preferentially a frame for the cut-through transfer over a frame for the store-and-forward transfer, and outputs the selected frame. Arbitration between the frame for the cut-through transfer and the frame for the store-and-forward transfer can be made using a commonly used method without being subjected to restriction.

The transfer processing unit 6 also has a function of preferentially selecting and outputting the cut-through mode. The transmission processing unit 7 performs a transmission process on a physical layer or the like of the input frame, and transmits to a transfer destination via the port 20-2 the frame having been subjected to the transmission process.

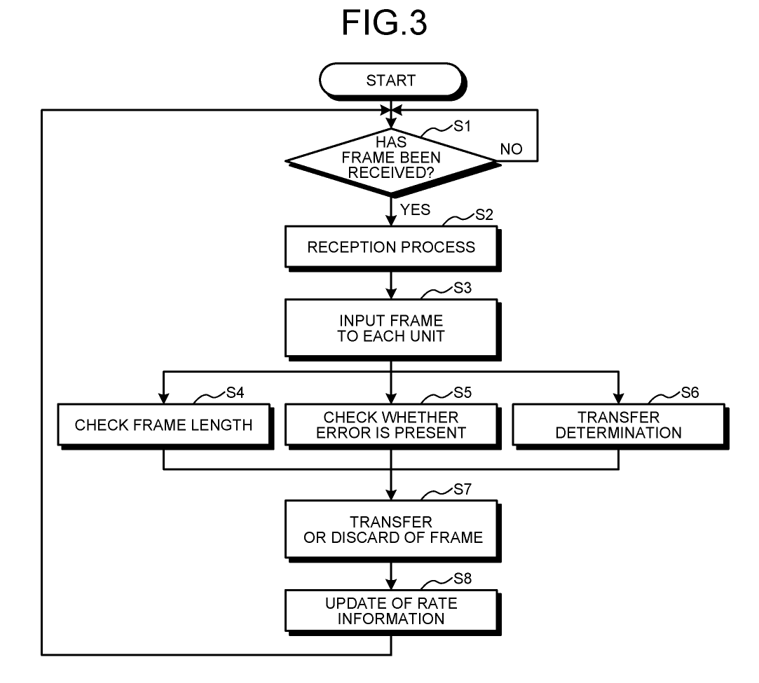

Next, a description will be made as to an operation performed by the communication apparatus 100 of the present embodiment. FIG. 3 is a flowchart illustrating an example of an overall operation performed by the communication apparatus 100. As illustrated in FIG. 3, the reception processing unit 2 determines whether a frame has been received from the port 20-1 (Step S1). In a case where the frame has been received (Step S1 Yes), the reception processing unit 2 performs a reception process on the frame (Step S2). The reception processing unit 2 outputs the received frame to the frame length analysis unit 3, the error detection unit 4, and the policer unit 5. In a case where the frame has not been received (Step S1 No), the reception processing unit 2 repeats Step S1.

The frame length analysis unit 3 checks a frame length of the input frame, that is, measures the frame length (Step S4). The error detection unit 4 performs an error detection process on the input frame to check whether an error is present (Step S5). The policer unit 5 performs transfer determination when the frame is input (Step S6). Step S4, Step S5, and Step S6 are performed in parallel. Details of the process of Step S6 will be described later.

The policer unit 5 transfers or discards the frame depending on a result of the transfer determination (Step S7). When the policer unit 5 transfers the frame, in particular, the frame is transferred out of the port 20-2 via the transfer processing unit 6 and the transmission processing unit 7. Furthermore, the policer unit 5 updates the rate information as described above on the basis of the frame length, the result of the transfer determination, and a result of error determination (Step S8). That is, on the basis of the transfer determination result and the error detection result, in Step S8, the policer unit 5 does not add the frame length to the rate information when determining to discard the frame, and the policer unit 5 adds the frame length to the rate information when determining to transfer the frame. Among the second frames, i.e., the frames received in the past is a frame which the error detection unit 4 determines as including no error. In a case of determining whether to discard the frame depending on the error detection result by the error detection unit 4, the rate information is calculated on the basis of a frame length of such an error-free frame. The update of the rate information in Step S8 includes not adding the frame length to the rate information, which does not actually change the value. After Step S8, the process performed by the communication apparatus 100 returns to Step S1.

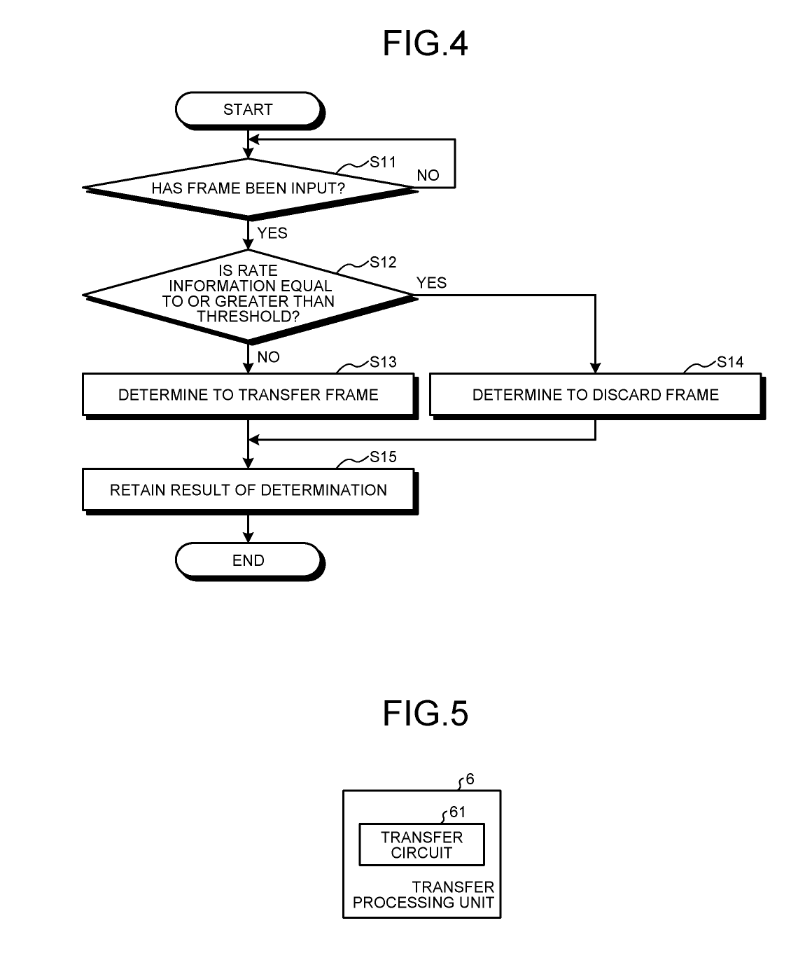

FIG. 4 is a flowchart illustrating an example of a processing procedure of the transfer determination in Step S6. First, the selection circuit 52 of the policer unit 5 determines whether the frame has been input (Step S11). As described above, when detecting the start of input of the frame from the reception processing unit 2, the selection circuit 52 outputs the frame reception notification to the bandwidth monitoring circuit 51. In a case where the frame has not been input (Step S11 No), the selection circuit 52 repeats Step S11.

In a case where the frame has been input (Step S11 Yes), the bandwidth monitoring circuit 51 that has received the frame reception notification from the selection circuit 52 determines whether the rate information is equal to or greater than the threshold (Step S12). When the rate information is less than the threshold (Step S12 No), the bandwidth monitoring circuit 51 determines to transfer the frame (Step S13), retains a result of the determination (Step S15), and ends the transfer determination. When the rate information is equal to or greater than the threshold (Step S12 Yes), the bandwidth monitoring circuit 51 determines to discard the frame (Step S14), and proceeds to Step S15.

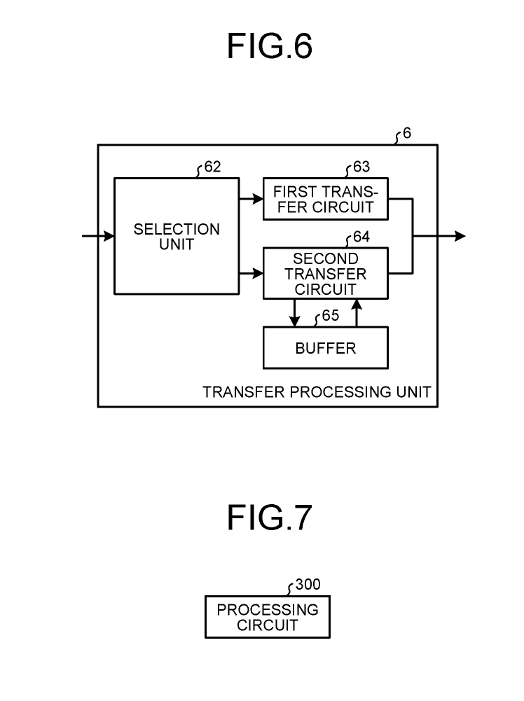

FIGS. 5 and 6 are diagrams each illustrating an example configuration of the transfer processing unit 6. In a case of performing the cut-through transfer only, the transfer processing unit 6 includes a transfer circuit 61 that performs the cut-through transfer, as illustrated in FIG. 5. In a case of performing the cut-through transfer and the store-and-forward transfer, the transfer processing unit 6 includes a selection unit 62, a first transfer circuit 63, a second transfer circuit 64, and a buffer 65, as illustrated in FIG. 6. The first transfer circuit 63 is a transfer circuit that performs the cut-through transfer, and the second transfer circuit 64 is a transfer circuit that performs the store-and-forward transfer. The buffer 65 is used for storing a frame for the store-and-forward transfer. The selection unit 62 outputs a frame to the first transfer circuit 63 or the second transfer circuit 64 depending on information stored in the header of the input frame and the like, and performs output control, i.e., arbitration of the frame output from the first transfer circuit 63 or the second transfer circuit 64.

Although the above description is made with reference to the example in which the frame is discarded by the selection circuit 52, the place where the frame is discarded is not limited to the selection circuit 52. For example, the policer unit 5 may notify the transfer processing unit 6 or the transmission processing unit 7 of the discard instruction, and the transfer processing unit 6 or the transmission processing unit 7 may perform discard on the basis of the discard instruction.

The functional configurations illustrated in FIGS. 1, 2, 5, and 6 are merely examples, and the function sharing of each functional unit is not limited to the example described above.

Next, a hardware configuration of the communication circuit 1 of the communication apparatus 100 will be described. The processing circuit that implements the communication circuit 1 may be a processing circuit that is dedicated hardware or a control circuit that includes a processor. The respective units illustrated in FIGS. 1, 2, 5 and 6 may be implemented by individual processing circuits, or two or more of the units may be implemented by one processing circuit. When the processing circuit is dedicated hardware, the processing circuit is a processing circuit 300 illustrated in FIG. 7. FIG. 7 is a diagram illustrating the processing circuit of the first embodiment. The processing circuit 300 is, for example, a single circuit, a composite circuit, a programmed processor, a parallel programmed processor, an application specific integrated circuit (ASIC), a field programmable gate array (FPGA), or a combination thereof.

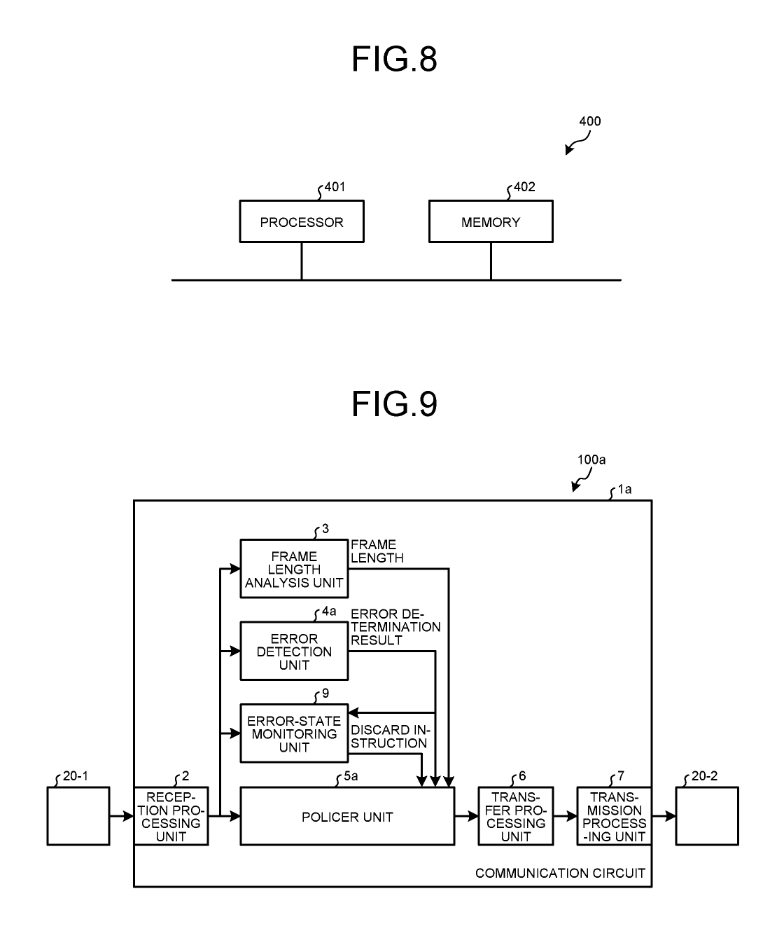

When the processing circuit that implements the communication circuit 1 is implemented by a control circuit including a processor, the control circuit is a control circuit 400 configured as illustrated in FIG. 8, for example. FIG. 8 is a diagram illustrating an example configuration of the control circuit 400 of the first embodiment. The control circuit 400 includes a processor 401 and a memory 402. The processor 401 is a central processing unit (CPU, also referred to as a central processing device, a processing device, an arithmetic device, a microprocessor, a microcomputer, a processor, and a digital signal processor (DSP)) or the like. The memory 402 corresponds to, for example, a nonvolatile or volatile semiconductor memory such as a RAM, a ROM, a flash memory, an erasable programmable read only memory (EPROM), or an electrically erasable programmable read only memory (EEPROM), and a magnetic disk.

When the processing circuit that implements the communication circuit 1 is the control circuit 400 including the processor, the processing circuit is realized by the processor 401 reading a program that is stored in the memory 402 and in which a process of each unit is described, and executing the program. The memory 402 is also used as a temporary memory in each process performed by the processor 401.

As described above, in the present embodiment, bandwidth limitation is performed on the basis of a bandwidth, that is, the amount of data unit time value using frame lengths of frames previously received including a frame received immediately before the currently received frame. The cut-through transfer is performed thereafter. For this reason, the communication apparatus 100 according to the first embodiment can achieve the transfer in the cut-through mode and perform the bandwidth limitation.

### Second Embodiment

FIG. 9 is a diagram illustrating an example configuration of a communication apparatus according to a second embodiment of the present invention. As illustrated in FIG. 9, the communication apparatus 100a of the second embodiment includes a communication circuit 1a and the ports 20-1 and 20-2 that are communication ports. Elements having functions similar to those in the first embodiment are denoted by the same reference numerals as those in the first embodiment, and overlapping descriptions will be omitted. Hereinafter, differences from the first embodiment will be described.

The first embodiment has been described as to the configuration and the method for performing bandwidth limitation on the frame for the cut-through transfer. The communication apparatus 100 of the first embodiment does not take into consideration whether a destination of a transferred frame, i.e., a reception apparatus receiving the transferred frame determines the transferred frame as being erroneous. For this reason, the communication apparatus 100 transfers even a frame having an error occurred frequently. Generally, a relay apparatus such as the communication apparatus 100 of the first embodiment performs a simple error detection process as compared with an error detection process performed by a reception-side apparatus, or performs a small number of types of error detection processes as compared with error detection processes performed by a reception apparatus. As a result, some frames are determined as being erroneous on the reception side despite the fact that the communication apparatus 100 does not determine such a frame as including an error. For this reason, the communication apparatus 100 would transfer a large number of frames determined as being erroneous on the reception side, thereby hindering communication of normal frames. In particular, in a case where the communication apparatus 100 transfers the frame without taking into consideration the error detection result, communication frames having errors occurred frequently put a squeeze on the bandwidth in the network. In the present embodiment, an error rate of a frame determined by the reception apparatus as being erroneous is monitored, and transfer is performed in consideration of the error rate in the reception apparatus. Hereinafter, the error rate in the reception apparatus is also referred to as the error rate on the reception side.

As illustrated in FIG. 9, the communication circuit 1a of the second embodiment is similar to the communication circuit 1 of the first embodiment, except that the communication circuit la includes an additional error-state monitoring unit 9, and an error detection unit 4a and a policer unit 5a, not the error detection unit 4 and the policer unit 5. In the present embodiment, when receiving a frame, the reception processing unit 2 outputs the received frame to the frame length analysis unit 3, the error detection unit 4a, the policer unit 5a, and the error-state monitoring unit 9.

The error detection unit 4a performs both an error detection process similar to that in the first embodiment and an error detection process similar to the error detection process performed by the reception apparatus, and outputs error detection results to the policer unit 5a and the error-state monitoring unit 9. The error detection results output from the error detection unit 4a include a first error detection result and a second error detection result. The first error detection result that is an error detection result by the error detection process similar to that in the first embodiment. The second error detection result is an error detection result by the error detection process similar to the error detection process performed by the reception apparatus. The error detection process performed by the reception apparatus is a given error detection process such as error detection using FCS as with he error detection process of the first embodiment. The error detection process performed by the reception apparatus is a known one. Alternatively, even when the error detection process performed in the reception apparatus is not a known one, the error detection unit 4a may be set to perform an error detection process presumed to be performed in the reception apparatus as the error detection process performed by the reception apparatus.

On the basis of the second error detection result input from the error detection unit 4a, the error-state monitoring unit 9 updates the error rate indicating an error state. Hereinafter, the error state indicates a frequency at which frames are determined by the reception apparatus as being erroneous. The error rate is information indicating the frequency of errors in the reception apparatus, and can be defined using, for example, the number of error bits, the number of error bytes, or the number of error frames within a fixed period of time or within a fixed number of frames.

The error-state monitoring unit 9 checks the error state by using the error rate. Specifically, the error-state monitoring unit 9 sets a discard instruction to be effective or ineffective as a result of comparison of the error rate with a first threshold and a second threshold. The first threshold is a threshold used for determining whether to make the discard instruction effective, and the second threshold is a threshold used for determining whether to cancel the discard instruction, that is, to make the discard instruction ineffective.

As described above, the error-state monitoring unit 9 calculates the error rate of the received frame on the basis of the error detection result by the error detection unit 4, and determines whether to discard the first frame on the basis of the error rate.

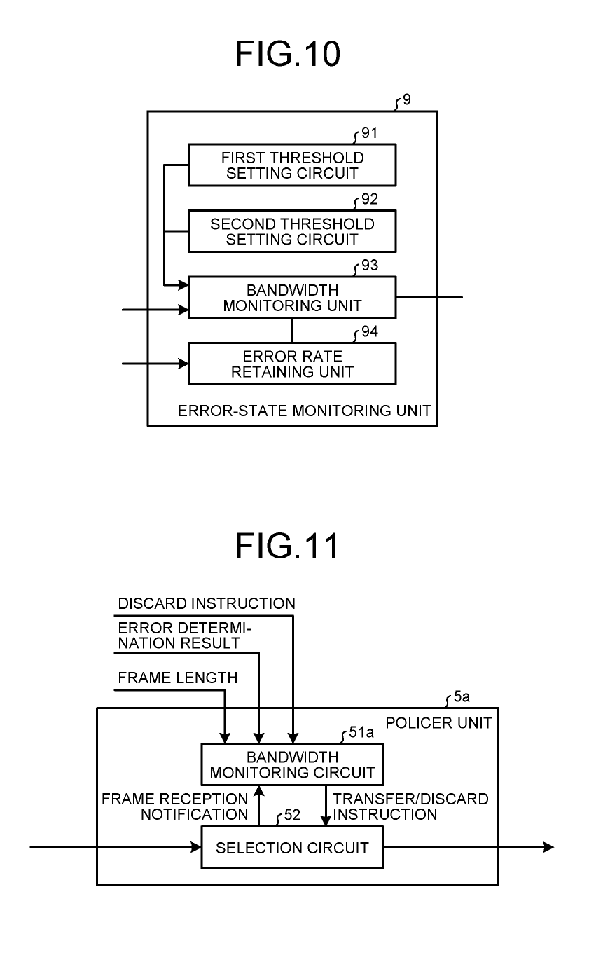

FIG. 10 is a diagram illustrating an example configuration of the error-state monitoring unit 9. As illustrated in FIG. 10, the error-state monitoring unit 9 includes a first threshold setting circuit 91 that sets a first threshold, a second threshold setting circuit 92 that sets a second threshold, a bandwidth monitoring unit 93, and an error rate retaining unit 94. The first threshold setting circuit 91 and the second threshold setting circuit 92 may be circuits that retain the predetermined first threshold and the second threshold as fixed values respectively, or may be circuits that can respectively update the first threshold and the second threshold when receiving, from outside, requests for updating the first threshold and the second threshold.

The error rate retaining unit 94 retains an error rate and, when an error detection result is input, updates the error rate on the basis of the error detection result. When a frame is input, the bandwidth monitoring unit 93 acquires the first threshold and the second threshold from the first threshold setting circuit 91 and the second threshold setting circuit 92, respectively, and sets the discard instruction to be effective or ineffective using the error rate, the first threshold, and the second threshold. In addition, the bandwidth monitoring unit 93 retains flag information indicating whether the discard instruction is effective or ineffective. When the flag information indicates that the discard instruction is effective, the bandwidth monitoring unit 93 outputs the discard instruction to the policer unit 5a each time a frame is input.

The token bucket method, the jumping window method, or the like using the first threshold and the second threshold may be used for determining whether the discard instruction is effective or ineffective in the bandwidth monitoring unit 93, but there is no limitation thereto.

FIG. 11 is a diagram illustrating an example configuration of the policer unit 5a. The policer unit 5a includes a bandwidth monitoring circuit 51a and the selection circuit 52 similar to that in the first embodiment. The bandwidth monitoring circuit 51a performs policing similarly to the first embodiment, but differs from the bandwidth monitoring circuit 51 of the first embodiment in the following points. Upon receiving the discard instruction from the error-state monitoring unit 9, the bandwidth monitoring circuit 51a outputs the discard instruction to the selection circuit 52. The bandwidth monitoring circuit 51a retains information as to whether the discard instruction has been given, and when updating the rate information using the frame length, does not add, to the rate information, the frame length of the frame for which the discard instruction has been given. When the bandwidth monitoring circuit 51a does not receive the discard instruction from the error-state monitoring unit 9 after the frame is input, the bandwidth monitoring circuit 51a determines whether to perform transfer by policing similarly to the first embodiment. In accordance with a result of this determination, then, the bandwidth monitoring circuit 51a outputs the transfer instruction or the discard instruction to the selection circuit 52 similarly to the first embodiment.

The error detection unit 4a may not perform an error detection process similar to that in the first embodiment. That is, the error detection unit 4a may perform only the error detection process similar to that of the reception apparatus. In that case, the policer unit 5a does not perform discard or transfer determination depending on the result of the error detection process similar to that in the first embodiment, that is, the first error detection result.

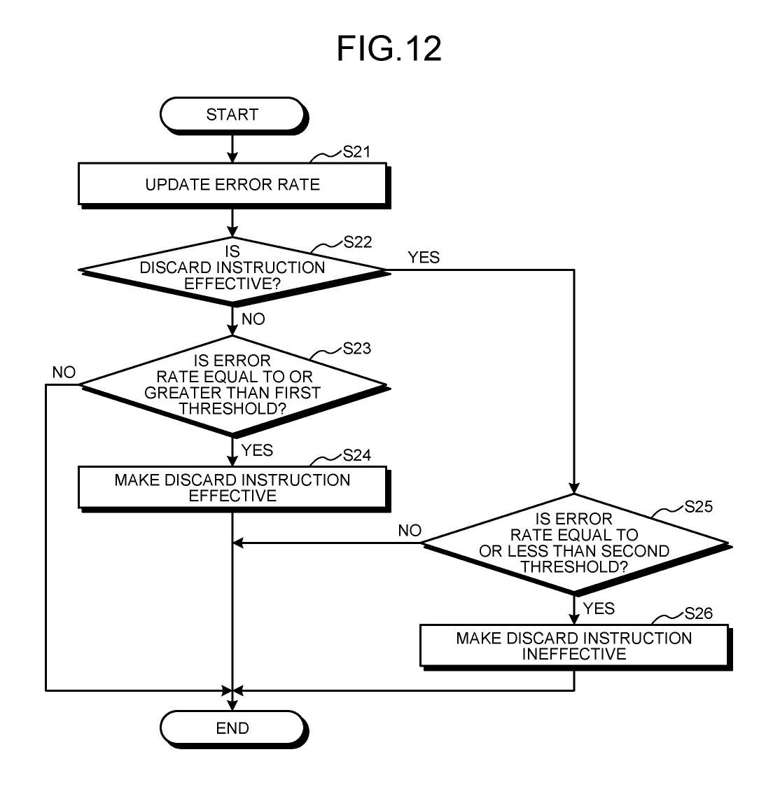

Next, an operation of the present embodiment will be described. FIG. 12 is a flowchart illustrating an example of a processing procedure performed by the error-state monitoring unit 9. FIG. 12 illustrates a process with an error detection result received, and the process illustrated in FIG. 12 is performed each time an error detection result is received. Upon receiving the error detection result, the error-state monitoring unit 9 updates the error rate (Step S21). The error-state monitoring unit 9 determines whether the discard instruction is effective on the basis of the retained flag information (Step S22). An initial value of the flag information is a value indicating that the discard instruction is ineffective.

When the error-state monitoring unit 9 determines that the discard instruction is not effective, that is, the discard instruction is ineffective (Step S22 No), the error-state monitoring unit 9 determines whether the error rate is equal to or greater than the first threshold (Step S23). Although, in this embodiment, the error-state monitoring unit 9 determines whether the error rate is equal to or greater than the first threshold, the error-state monitoring unit 9 may determine whether the error rate exceeds the first threshold. When the error rate is equal to or greater than the first threshold (Step S23 Yes), the error-state monitoring unit 9 makes the discard instruction effective (Step S24) and terminates the process. Specifically, in Step S24, the error-state monitoring unit 9 changes the retained flag information to a value indicating that the discard instruction is effective. When the error rate is less than the first threshold (Step S23 No), the error-state monitoring unit 9 terminates the process, keeping the discard instruction ineffective.

When the error-state monitoring unit 9 determines that the discard instruction is effective (Step S22 Yes), the error-state monitoring unit 9 determines whether the error rate is equal to or less than the second threshold (Step S25). Although, in this embodiment, the error-state monitoring unit 9 determines whether the error rate is equal to or less than the second threshold, the error-state monitoring unit 9 may determine whether the error rate is less than the second threshold. When the error rate is equal to or less than the second threshold (Step S25 Yes), the error-state monitoring unit 9 makes the discard instruction ineffective (Step S26) and terminates the process. Specifically, in Step S26, the error-state monitoring unit 9 changes the retained flag information to a value indicating that the discard instruction is ineffective. When the error rate is larger than the second threshold (Step S25 No), the error-state monitoring unit 9 terminates the process without changing the flag information.

As described above, when a frame is input and the discard instruction is effective, the error-state monitoring unit 9 outputs the discard instruction to the policer unit 5a.

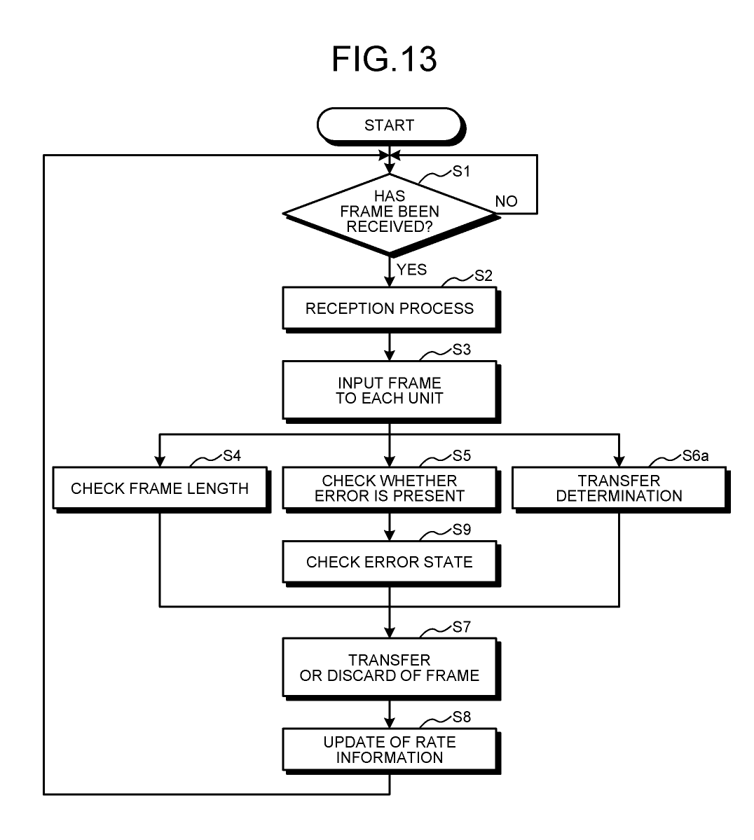

FIG. 13 is a flowchart illustrating an example of an overall operation performed by the communication apparatus 100a of the present embodiment. As illustrated in FIG. 13, the overall operation performed by the communication apparatus 100a is the same as the overall operation performed by the communication apparatus 100 illustrated in FIG. 3, except that the overall operation of FIG. 13 involves additional Step S9, and, instead of S6, Step S6a. Hereinafter, operations of FIG. 13 different from those in the first embodiment will be described.

After Step S5, the error-state monitoring unit 9 checks the error state on the basis of the error determination result (Step S9). Specifically, in Step S9, the process illustrated in FIG. 12 is performed.

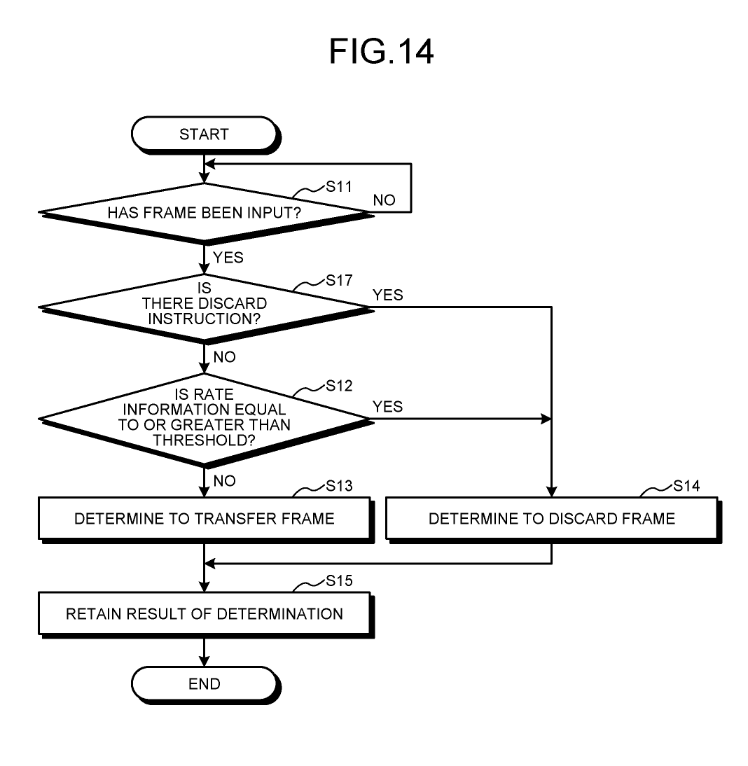

FIG. 14 is a flowchart illustrating an example of a processing procedure of transfer determination in Step S6a. In a case of “Yes” in Step S11, the selection circuit 52 of the policer unit 5a determines whether the discard instruction has been input from the error-state monitoring unit 9 (Step S17). In a case where the discard instruction has been input (Step S17 Yes), the process proceeds to Step S14. In a case where the discard instruction is not input in spite of a lapse of a fixed period of time from the start of input of a frame (Step S17 No), the process proceeds to Step S12. Step S12 and the subsequent steps are similar to those in the first embodiment.

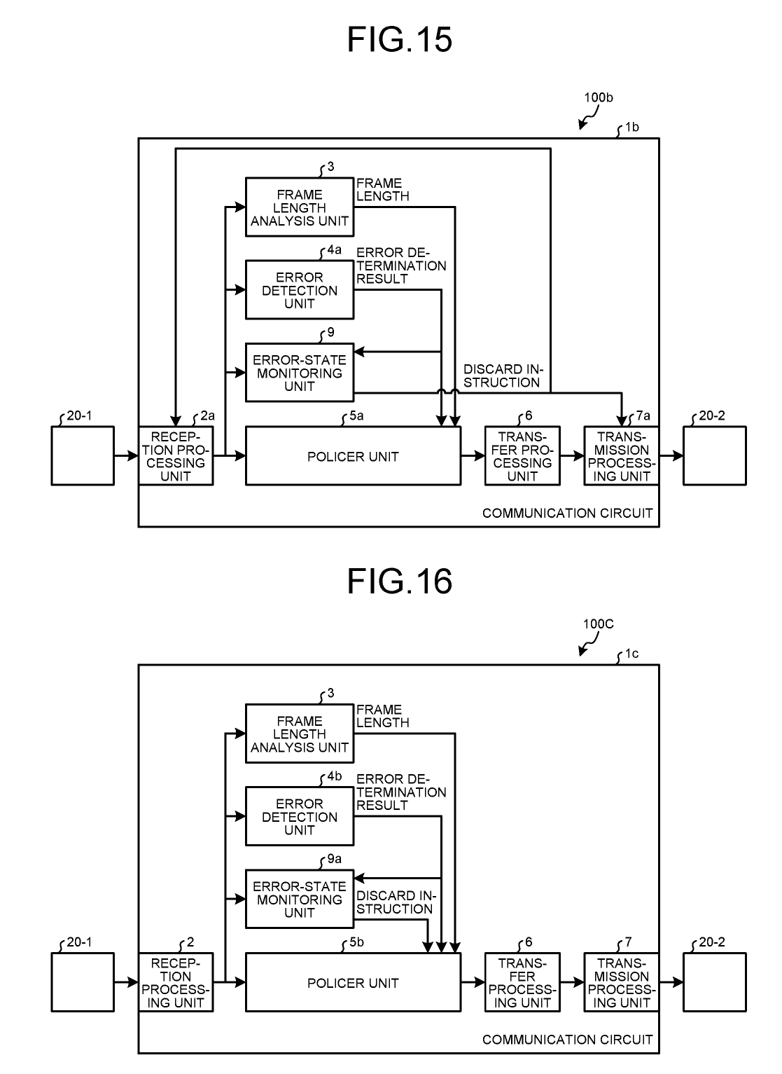

Although the above description has been made as to an example in which the frame is discarded in the policer unit 5a when the error-state monitoring unit 9 outputs the discard instruction, a component other than the policer unit 5a may discard the frame based on the discard instruction output by the error-state monitoring unit 9. FIG. 15 is a diagram illustrating an example configuration of a communication apparatus in a case where the discard of the frame is performed by a component other than the policer unit 5a. The communication apparatus 100b illustrated in FIG. 15 includes a communication circuit 1b and the ports 20-1 and 20-2. Similarly to the example illustrated in FIG. 9, the communication circuit 1b includes the error-state monitoring unit 9, and, instead of the reception processing unit 2 and the transmission processing unit 7, includes a reception processing unit 2a and a transmission processing unit 7a. In the example configuration illustrated in FIG. 15, the error-state monitoring unit 9 outputs the discard instruction to the reception processing unit 2a and the transmission processing unit 7a. When given the discard instruction, the reception processing unit 2a and the transmission processing unit 7a perform a process of closing the ports. In addition, when canceling the discard instruction, the error-state monitoring unit 9 notifies the reception processing unit 2a or the transmission processing unit 7a accordingly. Alternatively, instead of the process of closing the ports, the reception processing unit 2a and the transmission processing unit 7a may discard all frames. Alternatively, one of the reception processing unit 2a and the transmission processing unit 7a may discard the frame when the one unit is given the discard instruction.

The communication circuit 1a and the communication circuit 1b of the present embodiment can be implemented by a processing circuit similarly to the first embodiment.

As described above, in the present embodiment, since determination whether to discard the frame is performed on the basis of the error rate in the reception apparatus in addition to the process similar to that in the first embodiment, failure of the network can be suppressed even in a case where there occurs a large amount of error frames.

### Third Embodiment

FIG. 16 is a diagram illustrating an example configuration of a communication apparatus according to a third embodiment of the present invention. As illustrated in FIG. 16, the communication apparatus 100c of the third embodiment includes a communication circuit 1c and the ports 20-1 and 20-2 that are communication ports. Elements having functions similar to those in the first embodiment and the second embodiment are denoted by the same reference numerals as those in the first embodiment and the second embodiment, and overlapping descriptions will be omitted. The third embodiment differs from the first embodiment and the second embodiment in the respects as will be described hereinbelow.

The first and second embodiments have been described with reference to the example in which frames received from one port are not distinguished. However, in the present embodiment, a description will be made as to a method of classifying frames received by one port into multiple traffic types, and limiting a bandwidth on a traffic-type-by-traffic-type basis. The traffic type in the present embodiment is a unit indicating a sequential flow of communication, which is also called “a flow”. For example, the traffic type can be identified on the basis of at least one of header information of a frame or address information stored in a head portion of a payload, a frame type, virtual local area network (VLAN)-identifier (ID), a logical port number, priority, a transfer type, and information indicating whether it is multicast, broadcast or unicast. The frame stores therein information for identifying the above-described traffic type, and the information for identifying the traffic type is hereinafter referred to as traffic identification information. The transfer type is information indicating whether to perform cut-through transfer or store-and-forward transfer.

As illustrated in FIG. 16, the communication circuit 1c of the present embodiment is similar to the communication circuit 1a of the second embodiment, except that the communication circuit 1c includes an error detection unit 4b, a policer unit 5b, and an error-state monitoring unit 9a, instead of the error detection unit 4a, the policer unit 5a, and the error-state monitoring unit 9.

The error detection unit 4b of the present embodiment performs error detection on a traffic-type-by-traffic-type basis, and outputs an error determination result together with information indicating traffic to the policer unit 5b and the error-state monitoring unit 9a. The error-state monitoring unit 9a performs a process similar to that in the second embodiment on a traffic-type-by-traffic-type basis. That is, the error-state monitoring unit 9a retains flag information indicating whether the discard instruction is effective or ineffective on a traffic-type-by-traffic-type basis, and retains the error rate on a traffic-type-by-traffic-type basis. Then, the error-state monitoring unit 9a updates the flag information and the error rate on a traffic-type-by-traffic-type basis. The first threshold and the second threshold may be individually set on a traffic-type-by-traffic-type basis or may be set to a common value regardless of the traffic types.

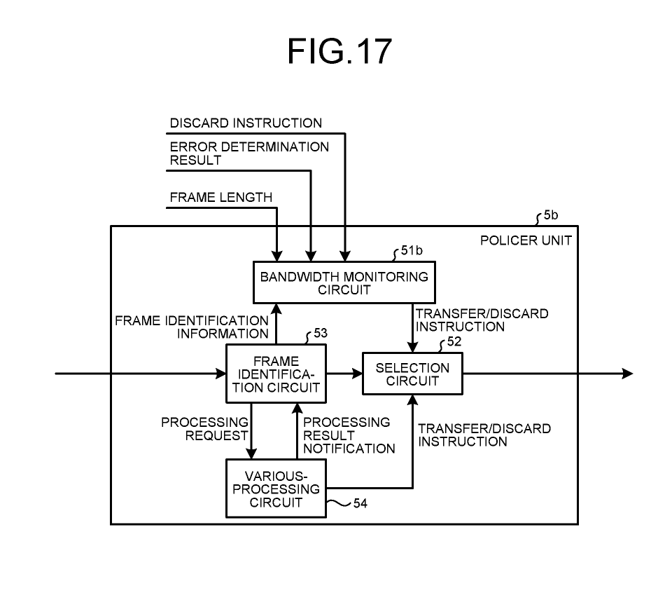

FIG. 17 is a diagram illustrating an example configuration of the policer unit 5b. As illustrated in FIG. 17, the policer unit 5b includes a bandwidth monitoring circuit 51b, the selection circuit 52, a frame identification circuit 53, and a various-processing circuit 54.

The frame identification circuit 53 identifies the traffic type of a frame on the basis of the traffic identification information in the frame, and outputs, to the bandwidth monitoring circuit 51b, the frame identification information that is the identified information. The frame identification information indicates the traffic type, and is, for example, a number predetermined for each traffic type. The various-processing circuit 54 retains information used for determination of a frame type. In response to a processing request from the frame identification circuit 53, the various-processing circuit 54 outputs, to the frame identification circuit 53a, a processing result that is the information used for determining the frame type. For example, the various-processing circuit 54 retains correspondence between the frame identification information and the information indicating the frame type. When the frame identification circuit 53 notifies the various-processing circuit 54 of the frame identification information through the processing request, the various-processing circuit 54 outputs, to the frame identification circuit 53, a processing result that is information indicating the traffic type.

The bandwidth monitoring circuit 51b performs the same operation as that of the bandwidth monitoring circuit 51a of the second embodiment on a traffic-type-by-traffic type basis. The bandwidth monitoring circuit 51b retains rate information on a traffic-type-by-traffic-type basis, and performs, for example, policing on a traffic-type-by-traffic-type basis. That is, the bandwidth monitoring circuit 51b is a bandwidth limitation unit that obtains rate information for each traffic type of the second frames and determines whether to discard the first frame on a traffic-type-by-traffic-type basis. The bandwidth monitoring circuit 51b outputs a transfer instruction or a discard instruction to the selection circuit 52 on a traffic-type-by-traffic-type basis. The thresholds, which the bandwidth monitoring circuit 51b uses for policing, may be common regardless of the traffic types or may be individually set on a traffic-type-by-traffic-type basis.

As described in the first embodiment and the second embodiment, the discard of the frame may be performed by a component other than the policer unit 5b. For example, the transmission processing unit or the reception processing unit may discard the frame on a traffic-type-by-traffic-type basis. The communication circuit 1c of the present embodiment can be implemented by a processing circuit similarly to the first embodiment.

Although the operation similar to that in the second embodiment is performed on a traffic-type-by-traffic-type basis in the above example, an operation similar to that in the first embodiment may be performed on a traffic-type-by-traffic-type basis.

As described above, in the present embodiment, policing is performed similarly to the second embodiment on a traffic-type-by-traffic-type basis. For this reason, it is possible to perform the cut-through transfer and bandwidth control on a traffic-type-by-traffic-type basis, thereby achieving more appropriate bandwidth control.

### Fourth Embodiment

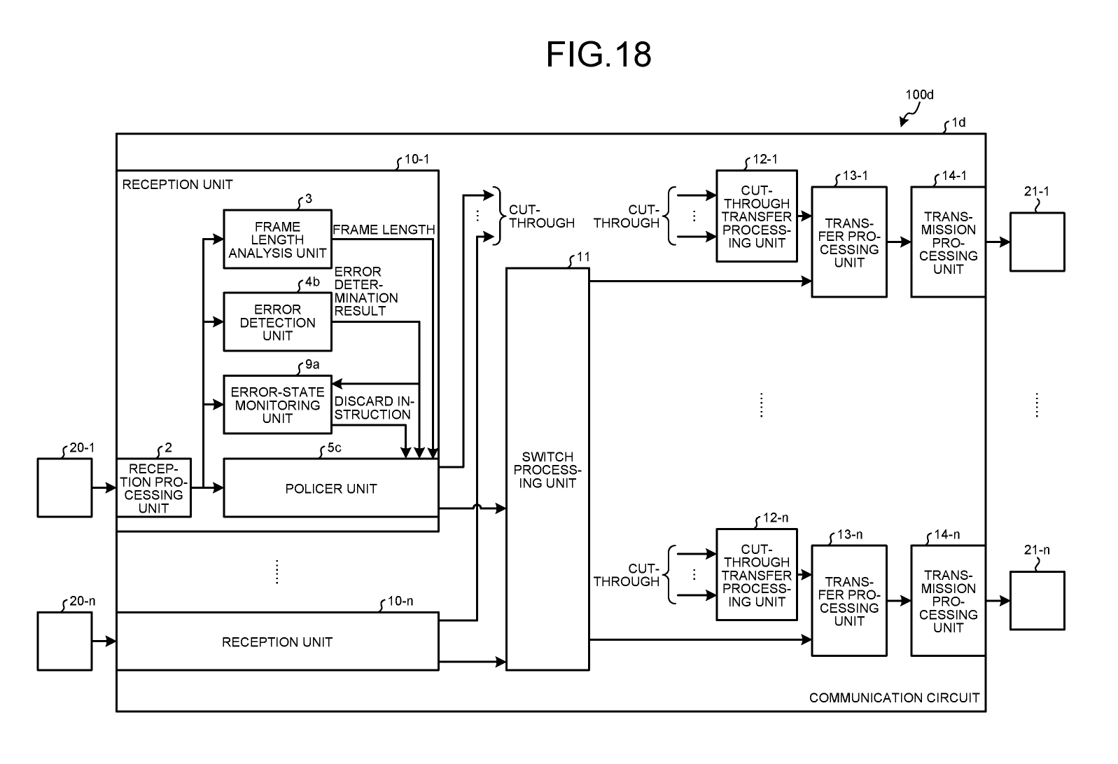

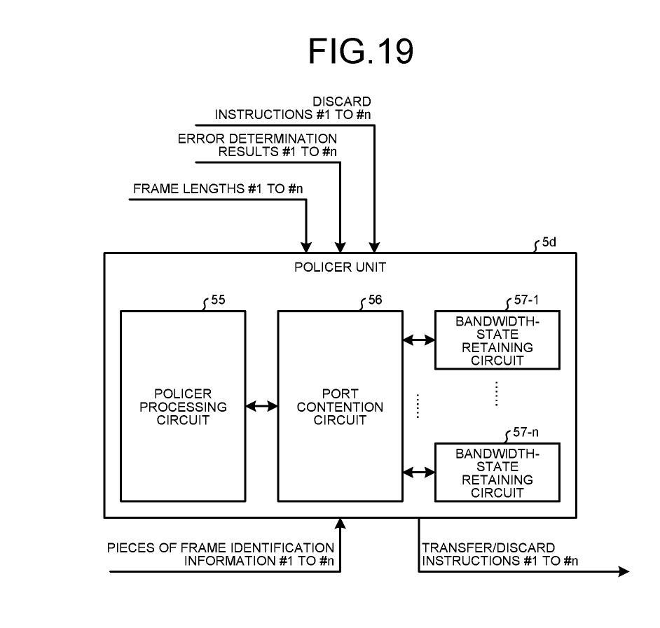

FIG. 18 is a diagram illustrating an example configuration of a communication apparatus according to a fourth embodiment of the present invention. As illustrated in FIG. 18, the communication apparatus 100d of the fourth embodiment includes a communication circuit 1d and ports 20-1 to 20-n and 21-1 to 21-n that are multiple ports. Elements having functions similar to those in any of the first to third embodiments are denoted by the same reference numerals as those in any of the first to third embodiments, and overlapping descriptions will be omitted. The fourth embodiment differs from the first embodiment, the second embodiment, and the third embodiment in the respects as will be described henreinbelow. Although the ports 20-1 to 20-2 and the ports 21-1 to 21-n are illustrated separately in FIG. 19, the ports may be input/output ports in which case the ports denoted by reference numerals with the identical suffix among the ports 20-1 to 20-2 and 21-1 to 21-n, may actually be the same.

In the fourth embodiment, a description will be made as to a method for limiting a bandwidth in a case where the communication apparatus 100d is a multiplexing apparatus capable of performing cut-through transfer of frames between multiple ports. The multiplexing apparatus is a communication apparatus capable of multiplexing frames received from two or more ports on a reception side and outputting the result of multiplexing to ports on a transmission side.

As illustrated in FIG. 18, the communication circuit 1d includes reception units 10-1 to 10-n, a switch processing unit 11, cut-through transfer processing units 12-1 to 12-n, transfer processing units 13-1 to 13-n, and transmission processing units 14-1 to 14-n. n is an integer of 2 or more.

The reception units 10-1 to 10-n are connected to their corresponding ports 20-1 to 20-n. Each of the reception units 10-1 to 10-n is configured to include a policer unit 5c, instead of the policer unit 5b of the communication circuit 1c of the third embodiment, and lacks the transfer processing unit 6 and the transmission processing unit 7 of the communication circuit 1c of the third embodiment. The transmission processing units 14-1 to 14-n are connected to their corresponding ports 21-1 to 21-n. The transmission processing units 14-1 to 14-n are the same as the transmission processing units of the first embodiment.

The configuration of the policer unit 5c is similar to that of the policer unit 5b of the third embodiment illustrated in FIG. 17, but, in the present embodiment, the frame identification circuit 53 of the policer unit 5c further identifies, when a frame is input, whether the frame is to be transferred in the cut-through mode or the store-and-forward mode. Then, the frame identification circuit 53 of the policer unit 5c performs a process similar to that in the third embodiment, on the frame to be transferred in the cut-through mode. That is, the frame identification circuit 53 of the policer unit 5c is an identification unit that determines, on a port-by-port basis, whether the received frame is to be transferred in the cut-through mode or the store-and-forward mode. The frame to be transferred in the store-and-forward mode is output by the frame identification circuit 53 to the switch processing unit 11. The frame to be transferred in the cut-through mode is output by the frame identification circuit 53 to the bandwidth monitoring circuit 51b that is the bandwidth limitation unit. In the present embodiment, frames to be transferred in the cut-through mode are output from the policer unit 5c to the cut-through transfer processing units 12-1 to 12-n corresponding to the ports 21-1 to 21-n directed to destinations of the transfer of the frames. Information for identifying whether a frame is to be transferred in the cut-through mode or the store-and-forward mode is stored in the frame. The selection circuit 52 retains information indicating the correspondence between a destination and a port with respect to a frame to be transferred in the cut-through mode. The frame to be transferred in the store-and-forward mode is output by the policer unit 5c to the switch processing unit 11.

The switch processing unit 11 can multiplex frames input from the reception units 10-1 to 10-n. That is, the switch processing unit 11 multiplexes the frames received by two or more ports among the multiple ports. The multiplexing method carried out in the switch processing unit 11 is similar to a general multiplexing method, and there is no particular restriction. In general, the switch processing unit 11 includes a buffer for each port on the reception side or for each port on the transmission side. The switch processing unit 11 stores input frames in the buffer, multiplexes the frames, and outputs the multiplexed frames to the transfer processing units 13-1 to 13-n corresponding to the ports 21-1 to 21-n directed to destinations of the transfer of the frames. The switch processing unit 11 may include the buffer not only for each port on the reception side or for each port on the transmission side but also for each port, for each priority class, and for each user.

In the present embodiment, a description has been made as to the example in which the reception units 10-1 to 10-n perform the policing similar to that in the third embodiment. However, the reception units 10-1 to 10-n may perform the policing similar to that in the first embodiment or the second embodiment.

In the above described example, the policer unit is provided on a port-by-port basis, that is, in each reception unit. However, the communication apparatus may include, on a port-by-port basis, only the frame identification circuit instead of the policer unit, and the policer unit illustrated in FIG. 19 may be provided between each reception unit and the cut-through transfer processing unit. FIG. 19 is a diagram illustrating another example configuration of a policer unit 5d. The policer unit 5d illustrated in FIG. 19 includes a policer processing circuit 55, a port contention circuit 56, and bandwidth-state retaining circuits 57-1 to 57-n. The policer processing circuit 55 has functions similar to those of the bandwidth monitoring circuit 51b of the policer unit 5b. The bandwidth-state retaining circuits 57-1 to 57-n may have a configuration in which serial processing can be sequentially performed with a plurality of ports separately from the frame identification circuit as the example in FIG. 9 of each port. Discard instructions #1 to #n, error determination results #1 to #n, frame notifications #1 to #n, and pieces of frame identification information #1 to #n corresponding to ports on the reception side are input to the policer unit 5d. The numerical values given after # indicate suffixes of reference numerals denoting the corresponding ports.

The bandwidth-state retaining circuits 57-1 to 57-n retain effective and ineffective states of the discard instruction and the rate information on the frames received at the corresponding ports. The port contention circuit 56 selects a reception port in relation to which the policer processing circuit 55 performs a process. That is, the port contention circuit 56 determines a port where the policer processing circuit 55 performs a process on a received frame. For example, the selection of the reception port for the policer processing circuit 55 may be performed such that processes of the ports are performed in a predetermined order at regular time intervals, or may be performed on the basis of a predetermined priority or the like. At that time, the port contention circuit 56 reads the effective and ineffective states of the discard instruction concerning the selected port, from any of the bandwidth-state retaining circuits 57-1 to 57-n corresponding thereto, reads the rate information, and notifies the policer processing circuit 55 thereof. The policer processing circuit 55 performs the policing process, similarly to the third embodiment, on the frame received at the port selected by the policer processing circuit 55, and notifies the port contention circuit 56 of a determination result. The port contention circuit 56 outputs the determination result received from the policer processing circuit 55, to any of the bandwidth-state retaining circuits 57-1 to 57-n corresponding to the port corresponding to the determination result. The policer unit 5d outputs transfer instructions or discard instructions #1 to #n to the corresponding ports. The numerical values given after # indicate suffixes of reference numeral denoting the corresponding ports.

In the present embodiment, the description has been made as to the configuration and method in which cut-through transfer and bandwidth limitation are performed in the communication apparatus that functions as the multiplexer. Thus, the communication apparatus of the present embodiment can perform the cut-through transfer and the bandwidth limitation even when transferring both a frame to be multiplexed and a frame to be transferred in the cut-through mode.

The configurations described in the embodiments above are merely examples of the content of the present invention and can be combined with other known technology and part thereof can be omitted or modified without departing from the gist of the present invention.

### REFERENCE SIGNS LIST

1, 1a, 1b, 1c communication circuit; 2 reception processing unit; 3 frame length analysis unit; 4 error detection unit; 5 policer unit; 6 transfer processing unit; 7 transmission processing unit; 10-1 to 10-n reception unit; 11 switch processing unit; 12-1 to 12-n cut-through transfer processing unit; 13-1 to 13-n transfer processing unit; 14-1 to 14-n transmission processing unit; 51, 51a, 51b bandwidth monitoring circuit; 52 selection circuit; 53 frame identification circuit; 54 various-processing circuit; 55 policer processing circuit; 56 port contention circuit; 57-1 to 57-n bandwidth-state retaining circuit; 100, 100a, 100b, 100c, 100d communication apparatus.

1-7. (canceled)

8. A communication apparatus comprising:
a bandwidth limiter to, when bandwidth limiter is notified of start of reception of a first frame, determine whether to discard or transfer the first frame on a basis of rate information indicating an amount of data per unit time calculated on a basis of a frame length and reception timing of a second frame received before the first frame; and
a transfer processor to transfer the first frame in a cut-through mode, the first frame being determined by the bandwidth limiter to be transferred.

9. The communication apparatus according to claim 8, comprising:
an error detector to determine whether there is an error in a received frame, wherein
the bandwidth limiter determines to discard the first frame determined by the error detector as including an error, and
the rate information is calculated on a basis of a frame length of a frame, among the second frames, determined by the error detector as including no error.

10. The communication apparatus according to claim 9, comprising:
an error monitor to calculate an error rate of a received frame on a basis of a result of error detection by the error detector and to determine whether to discard the first frame on a basis of the calculated error rate, wherein
the communication apparatus discards the first frame determined by the error monitor to be discarded.

11. The communication apparatus according to claim 8, comprising:
an error detector to determine whether there is an error in a received frame; and
an error monitor to calculate an error rate of a received frame on a basis of a result of error detection by the error detector and to determine whether to discard the first frame on a basis of the calculated error rate, wherein
the communication apparatus discards the first frame determined by the error monitor to be discarded.

12. The communication apparatus according to claim 8, wherein the bandwidth limiter obtains the rate information for each traffic type of the second frame and determines whether to discard the first frame for each traffic type of the first frame.

13. The communication apparatus according to claim 8, comprising:
a plurality of ports;
a switch processor to multiplex frames received by two or more ports among the ports; and
an identifier to determine, on a port-by-port basis, whether a received frame is to be transferred in a cut-through mode or a store-and-forward mode, wherein
the identifier outputs, to the switch processor, a frame to be transferred in the store-and-forward mode, and outputs, to the bandwidth limiter, a frame to be transferred in the cut-through mode.

14. A bandwidth control method comprising:
when start of reception of a first frame is notified, determining whether to discard or transfer the first frame on a basis of rate information indicating an amount of data per unit time calculated on a basis of a frame length and reception timing of a second frame that is a frame received before the first frame; and
transferring the first frame in a cut-through mode, the first frame being determined to be transferred.

15. The communication apparatus according to claim 9, wherein the bandwidth limiter obtains the rate information for each traffic type of the second frame and determines whether to discard the first frame for each traffic type of the first frame.

16. The communication apparatus according to claim 10, wherein the bandwidth limiter obtains the rate information for each traffic type of the second frame and determines whether to discard the first frame for each traffic type of the first frame.

17. The communication apparatus according to claim 11, wherein the bandwidth limiter obtains the rate information for each traffic type of the second frame and determines whether to discard the first frame for each traffic type of the first frame.

18. The communication apparatus according to claim 9, comprising:
a plurality of ports;
a switch processor to multiplex frames received by two or more ports among the ports; and
an identifier to determine, on a port-by-port basis, whether a received frame is to be transferred in a cut-through mode or a store-and-forward mode, wherein
the identifier outputs, to the switch processor, a frame to be transferred in the store-and-forward mode, and outputs, to the bandwidth limiter, a frame to be transferred in the cut-through mode.

19. The communication apparatus according to claim 10, comprising:
a plurality of ports;
a switch processor to multiplex frames received by two or more ports among the ports; and
an identifier to determine, on a port-by-port basis, whether a received frame is to be transferred in a cut-through mode or a store-and-forward mode, wherein
the identifier outputs, to the switch processor, a frame to be transferred in the store-and-forward mode, and outputs, to the bandwidth limiter, a frame to be transferred in the cut-through mode.

20. The communication apparatus according to claim 11, comprising:
a plurality of ports;
a switch processor to multiplex frames received by two or more ports among the ports; and
an identifier to determine, on a port-by-port basis, whether a received frame is to be transferred in a cut-through mode or a store-and-forward mode, wherein
the identifier outputs, to the switch processor, a frame to be transferred in the store-and-forward mode, and outputs, to the bandwidth limiter, a frame to be transferred in the cut-through mode.

21. The communication apparatus according to claim 12, comprising:
a plurality of ports;
a switch processor to multiplex frames received by two or more ports among the ports; and
an identifier to determine, on a port-by-port basis, whether a received frame is to be transferred in a cut-through mode or a store-and-forward mode, wherein
the identifier outputs, to the switch processor, a frame to be transferred in the store-and-forward mode, and outputs, to the bandwidth limiter, a frame to be transferred in the cut-through mode.

22. The communication apparatus according to claim 15, comprising:
a plurality of ports;
a switch processor to multiplex frames received by two or more ports among the ports; and
an identifier to determine, on a port-by-port basis, whether a received frame is to be transferred in a cut-through mode or a store-and-forward mode, wherein
the identifier outputs, to the switch processor, a frame to be transferred in the store-and-forward mode, and outputs, to the bandwidth limiter, a frame to be transferred in the cut-through mode.

23. The communication apparatus according to claim 16, comprising:
a plurality of ports;
a switch processor to multiplex frames received by two or more ports among the ports; and
an identifier to determine, on a port-by-port basis, whether a received frame is to be transferred in a cut-through mode or a store-and-forward mode, wherein
the identifier outputs, to the switch processor, a frame to be transferred in the store-and-forward mode, and outputs, to the bandwidth limiter, a frame to be transferred in the cut-through mode.

24. The communication apparatus according to claim 17, comprising:
a plurality of ports;
a switch processor to multiplex frames received by two or more ports among the ports; and
an identifier to determine, on a port-by-port basis, whether a received frame is to be transferred in a cut-through mode or a store-and-forward mode, wherein
the identifier outputs, to the switch processor, a frame to be transferred in the store-and-forward mode, and outputs, to the bandwidth limiter, a frame to be transferred in the cut-through mode.
